(19) United States
(12) Patent Application Publication
(10) Pub. No.: US 2008/0129625 A1
(43) Pub. Date: Jun. 5, 2008

(54) Low Profile Antenna

(76) Inventors: Bengt Inge Svensson, Molndal (SE); Anders Hook, Hindas (SE); Martin Nils Johansson, Molndal (SE); Joakim Johansson, Tollsjo (SE)

Correspondence Address: ERICSSON INC., 6300 LEGACY DRIVE, M/S EVR 1-C-11, PLANO, TX, 75024, US

(21) Appl. No.: 11/573,604

(22) PCT Filed: Jul. 13, 2004
(86) PCT No.: PCT/SE2004/001130

§ 371 Date: Feb. 12, 2007

(51) Int. Cl. H01Q 13/18

(52) U.S. Cl. 343/767

(57) ABSTRACT

The invention discloses an antenna (100, 100′, 400, 500) comprising walls in a conducting material: first (110, 410, 510) and second (120, 420, 520) main walls, a first end wall (130, 530) and a first and a second side wall. The first (110, 510) and second (120, 520) main walls extend in parallel to each other, and are joined by the first end wall (130, 530). The side walls also join the first and second main walls, so that a cavity with only one opening (105, 205, 505) is formed, a rectangular aperture which can be brought to radiate by a feed connection (207). Suitably, the antenna can also comprise a second end wall (140, 540) which extends from the second main wall (120) towards the first main wall (110), with the length of extension of the first main wall being such that the second end wall and the first main wall do not meet.

### TECHNICAL FIELD

The present invention relates to an antenna comprising a plurality of walls in an electrically conducting material, the walls being arranged to form a low-profile antenna which has a small depth, and which can thus easily be integrated into existing structures in small spaces.

### PRIOR ART

There is a great desire to develop antennas which can be integrated into existing or new structures without needing a great deal of volume or space for the antenna. Preferably, the antenna should offer great versatility regarding, for example, polarization and coverage.

### SUMMARY OF THE INVENTION

The desire stated above is addressed by the antenna of the present invention in that it discloses an antenna comprising a plurality of walls in an electrically conducting material. The walls comprised in the antenna of the invention are:
a first and a second main wall with respective lengths of extension,
a first end wall, and
a first and a second side wall.

According to the invention, the walls are arranged so that the first and second main walls extend parallel to each other and are joined by the first end wall. Additionally, the side walls also join or connect the first and second main walls, so that a structure with a cavity with only one opening is formed. The opening of the cavity is in the form of a rectangular aperture, which can be brought to radiate by a feed connection which is also comprised in the antenna.

Thus, in other words, an electrically conducting box or “trench” is offered by the invention, the box having an opening which can be brought to radiate. This box can easily be integrated into existing or new structures with minimal requirements for space.

As an alternative, the antenna of the invention can also comprise a second end wall which extends from the second main wall towards the first main wall. In this alternative solution, the length of extension of the first main wall is such that the second end wall and the first main wall do not meet. Thus, in this alternative, a box-like structure is created with an aperture which can be brought to radiate by a feed connection which is also comprised in this version of the antenna of the invention. The advantages which are offered by the first embodiment of the invention are also offered by this embodiment. This embodiment is more like a conducting “folded trench” than the “ordinary trench” described above.

Specific applications of these and other embodiments of the invention will be shown in the following detailed description.

### BRIEF DESCRIPTION OF THE DRAWINGS

The invention will be described in more detail in the following, with reference to the appended drawings, in which

FIGS. 1a and 1b show two different basic embodiments of an antenna according to the invention, and

FIG. 2 shows a cross section of an application of the antenna of the invention, and

FIG. 3 shows a cross section of another application of the invention, and

FIGS. 4a and 4b show another embodiment of the invention, and

FIGS. 5 and 6 show examples of other embodiments.

### EMBODIMENTS

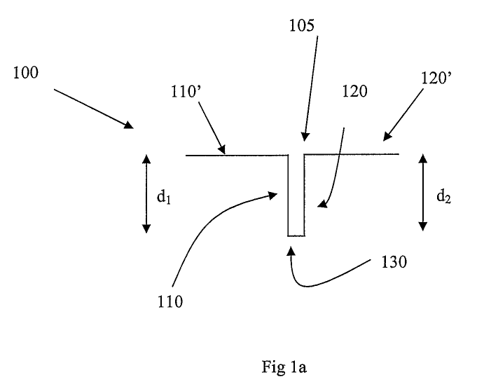

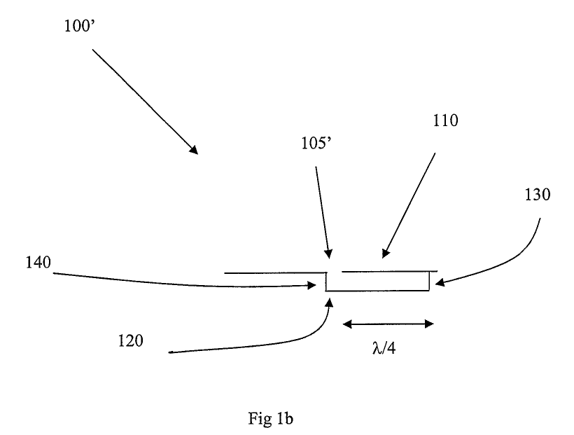

FIG. 1a shows a first embodiment 100 of an antenna of the invention. As shown in this drawing, the antenna 100 comprises a first 110 and a second 120 main wall, with respective lengths of extension d₁ and d₂. The two main walls are joined, preferably at their one end, by a first end wall 130.

The first and second side walls, 110, 120, as well as the first end wall 130, in this embodiment are flat and thin plates of an electrically conducting material, with the first and second side walls arranged so that they extend in parallel to each other, at a distance from each other, said distance being covered by the first end wall 130 as it joins the two main walls 110, 120. The first end wall has four side edges, a first and a second one of which are in contact with the first and second main walls.

In addition to the walls shown in FIG. 1a, the antenna also comprises first and second side walls, which are not shown in the drawing, but will have to be imagined by the reader. The first and second side walls also join the first and second main walls on those sides of the first end wall which are not in contact with the first and second main walls. In other words, the main walls together with the side walls form a box-like structure which is closed at one end by the first end wall. This embodiment will also be referred to as a “trench”-antenna.

Thus, the first embodiment of the antenna of the invention shown in FIG. 1a is an electrically conducting structure containing a cavity with only one opening or aperture, i.e. a square or rectangular aperture 105 extending from the first main wall 110 to the second main wall 120. This aperture can be brought to radiate by exciting the cavity of the structure 100 in a manner which will be elaborated on later in this description, thus causing the structure 100 to function as an antenna.

In the embodiment of FIG. 1a, the length d₂ of the second main wall is about λ/4, where λ is the wavelength in the cavity at the operating frequency of the antenna. Thus, an antenna for a desired frequency can be created by giving the main and side walls suitable lengths of extension, and/or by filling the cavity with a material with a suitable value of ∈, the electric permittivity constant.

As is also shown in FIG. 1a, the antenna 100 can be part of a larger structure by means of, for example, the first and second main walls 110, 120, being attached to other parts 110′, 120′ which are external to the antenna. A simple way of achieving this, and of designing the antenna 100, is to let the main walls be parts of a sheet of metal which is folded in order to form the main walls 110, 120, and the end wall 130.

FIG. 1b shows a second embodiment 100′ of the antenna of the invention. In this embodiment, the same basic principles as that shown in FIG. 1a and described above are adhered to. However, in this embodiment 100′, the box-like “trench” structure of FIG. 1a is replaced by a structure which might be described as a “folded trench”: in the embodiment of FIG. 1a, the first and second main wells are of equal lengths, which is not the case in FIG. 1b. The first 110 and second 120 main walls are, in this embodiment as well, joined by the first end wall 130, and extend in parallel to each other, both main walls still being flat and preferably plate-shaped. In addition, this embodiment also comprises first and second side walls, all of the walls being in an electrically conducting material.

The side walls are not shown in FIG. 1b either, but will have to be imagined by the reader as walls which connect the main walls, and extend at least the same length as the second main wall 120. The embodiment 100′ also comprises a second end wall 140 which extends from the second main wall 120 towards the first main wall 110, suitably from the end of the second main wall, but at least from a point in the second main wall which is chosen so that the second end wall does not reach the first main wall.

Suitably, the second end wall 140 has the same dimensions as the first end wall, at least in the direction from the second main wall towards the first main wall, but since the first main wall is shorter than the second main wall, the second end wall will not connect the two main walls. Both of the end walls should extend perpendicularly from the second main wall towards the first main wall.

Thus, an antenna 100′ with a “folded trench”-structure is created by using the embodiment of FIG. 1. The trench 100′ comprises an opening 105′ which corresponds to the difference in lengths between the first and second end walls.

As with the previous embodiment 100, the length of the trench, i.e. the length of the second main wall should be λ/4, where λ is the operating wavelength of the antenna. This is a general principle which is common to all of the embodiments of the present invention. However, if there is a need for smaller antennas than would be allowed by the dielectric constant of air, it is entirely within the scope of the invention to fill at least part of the antenna with a material with a dielectric constant different from that of air.

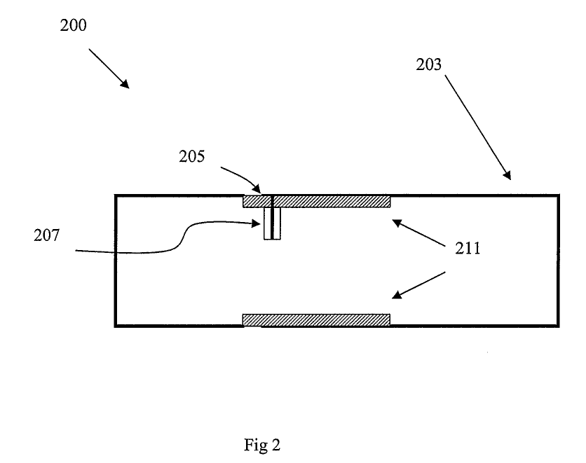

In FIG. 2, a practical application 200 of the embodiment 100′ from FIG. 1b is shown: the “trench” antenna 100′ has been wrapped around a cylindrical object 203, with FIG. 2 being a cross section of the object with the antenna wrapped around it. Thus, the two parts 211 of the antenna shown in FIG. 2 are merely an upper and a lower cross section of one and the same continuous antenna bent in a cylindrical shape.

One of the advantages of the invention emerges here: if one has an object such as the cylinder 203 to which one wishes to attach an antenna, this can be done merely by arranging a recess in the cylinder 203 with measurements which at least roughly correspond to the outer dimensions of the antenna.

The antenna is then arranged in the recess and the object 200 shown in FIG. 2, i.e. a cylinder with a built-in antenna, is obtained. The object 200 will have an aperture 205 as shown in FIG. 2, which will radiate due to a feeding structure also shown in FIG. 2.

The principles employed for the feed structure shown in FIG. 2 can suitably be used for all of the antennas of the present invention: the feed structure is attached to the first main wall, preferably in the vicinity of the aperture. The feed structure goes through one of the other walls, for example the second main wall, and attaches to said point in the first main wall. As an example, the feed structure can be in the shape of a coaxial cable.

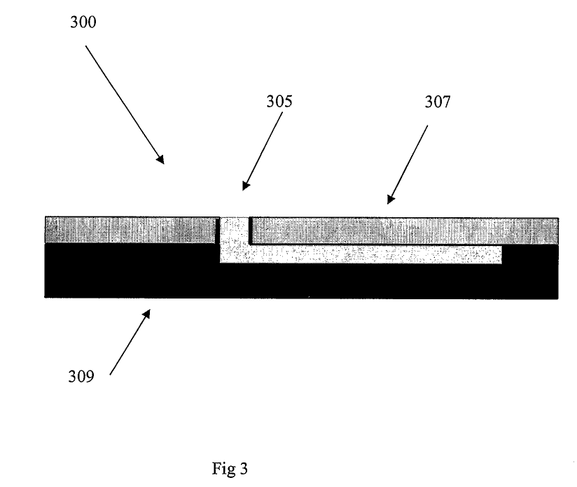

In FIG. 3, another advantage offered by the present invention is illustrated. If it is desired to obtain an antenna with a small RCS (Radar Cross Section), this is greatly facilitated by the embodiment 300 shown in FIG. 3: the antenna from FIG. 1b has been created by making a “folded trench” which adheres to the general principles described in connection to FIG. 1a. In this example, the folded trench has been manufactured from a solid piece of a material which is electrically conducting.

Since the only part of the antenna 300 according to the invention which needs to be electromagnetically visible to the outside world is the aperture, 305, the electrically conducting material 309 is then covered by Radar Absorbing Material (RAM) 307, so that the only part of the antenna which is not covered in RAM is the aperture.

In addition, RAM with an electrical thickness which is significantly shorter than λ/4 can be arranged to cover the antenna, including the aperture. The word “significantly” should here be taken to mean at least twice as short, preferably five times shorter

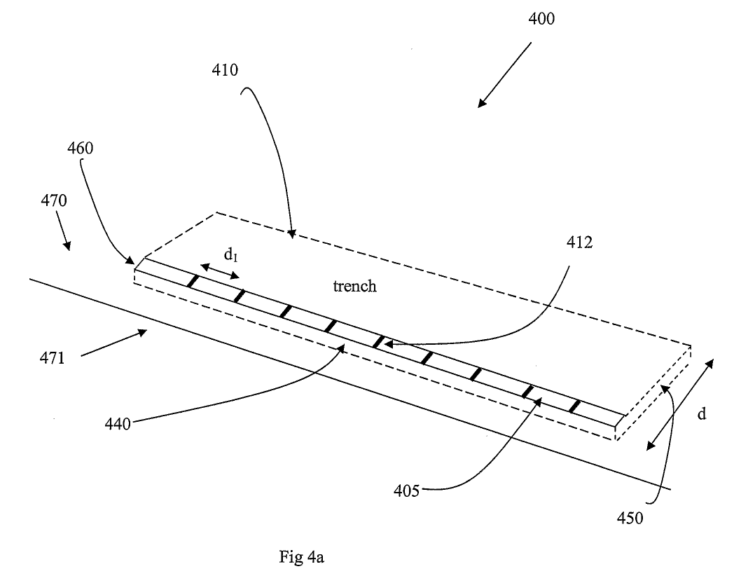

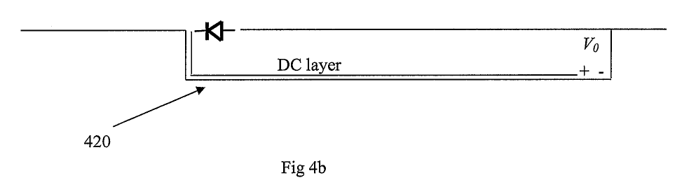

In FIG. 4a, another application 400 of the trench antenna of FIG. 1b is shown: in this embodiment it has been desired to equip the hull of, for example, a ship or an aircraft, with a low visibility antenna which does not require much volume for installation and which does not impede the aerodynamics or similar properties of the vessel/aircraft.

In order to achieve the mentioned objectives, the folded trench antenna of the invention has been used. The principles of the antenna will not be described again here, but the general principle is that a flat trench antenna has been created, with an aperture 405 which extends along one side of the antenna. The antenna 400 has then been arranged on the intended surface 470, i.e. the wing of an airplane or the hull of a ship or an airplane. Suitably, the antenna is arranged with the aperture 405 in parallel to a main surface of the hull or wing.

In FIG. 4a, a feature can be seen which has not been illustrated in previous drawings: the first side wall 450 is clearly seen in FIG. 4a, and the second side wall 460 is perceived, as the two side walls 450, 460, join the first man wall 410 and the second main wall, the second main wall in this case being “the bottom” of the antenna.

The central operating frequency λ of the antenna is defined as λ/4=d, where d is the length of the second main wall of the antenna.

Another feature of the invention is also shown in FIG. 4, a feature which can be employed with all of the embodiments of the invention. Said feature is used in order to reduce the RCS of the antenna 400: One or several diodes, preferably PIN-diodes, are arranged across the aperture of the antenna, extending from the first main wall to the second end wall, or in other words bridging the gap created by the fact that the first main wall is shorter than the second main wall.

The diode or diodes are employed in the following fashion: during Tx or Rx-phases of the antenna, the diode/-s are not made conducting. However, when the antenna is not in Tx or Rx-phase, the diodes are made conducting by applying the proper voltage. This will lead to the diodes creating a conducting mesh across the aperture, which in a known manner will significantly reduce the scattering by the antenna of foreign electromagnetic waves.

The distance d₁ between the diodes will then become significant, since d₁ should be significantly much smaller than one half of the shortest wavelength which is anticipated to be incident upon the antenna. Again, the word “significantly” should here be taken to mean at least twice as short, and preferably five times shorter

Thus, by positioning the diodes at chosen intervals, and by making them electrically conducting, the RCS of the antenna can be greatly reduced.

FIG. 4b shows another feature which may be incorporated into the antenna 400: the antenna 400 shown in FIG. 4a may exhibit DC-characteristics which would prohibit the diode arrangement. In order to enable the diode arrangement, a separate DC-layer may have to be introduced into “the trench”. As shown in FIG. 4b, this DC-layer comprises a conducting material arranged in parallel to the diode, close to the wall 420, but DC-isolated from it. This can, for example, be achieved by arranging the DC-layer in a dielectric material. Suitably, there is one common DC-layer for all of the diodes, but individual DC-layers for separate diodes is also a possibility.

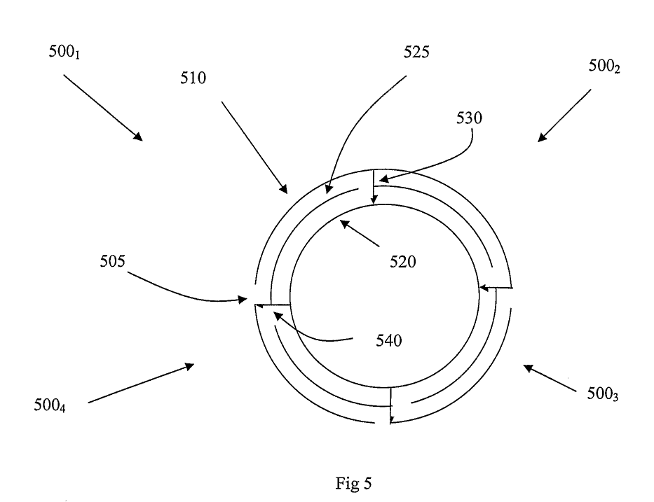

An antenna according to the invention can easily be integrated into existing structures such as, for example, masts. If the coverage offered by one antenna is not sufficient, more than one antenna may be integrated into one and the same structure. An example of this is shown in FIG. 5, with an additional feature also shown.

FIG. 5 shows a cross-sectional top view of a mast mounted antenna 500. The antenna 500 comprises four sub-antennas 500₁-500₄. All of the sub-antennas are similar to each other, and are versions of the “trench antenna” of FIG. 1b. However, in order to facilitate installation or integration into a circular mast, the first 510 and second 520 main walls of the sub-antennas are curved, so that the parallel property mentioned earlier makes the main walls concentric to each other.

The side walls may also suitably be correspondingly curved, in order to join the first and second main walls to each other. The end wall 530, however, is not curved but straight, and joins the two main walls at one end of the curve. Since the four curved antennas 500₁-500₄ are joined to each other around a circular mast, end walls can be shared between neighbouring antennas so that, for example, the first end wall 530 of one antenna 500₁ can serve as the second end wall of a neighbouring antenna 500₂.

The additional feature mentioned previously of the antenna 500 is as follows: in order to reduce the length of extension of the antenna(s), i.e. in the example with curved antennas in order to reduce the circumference, the individual antennas 500₁-500₄ comprise a third main wall 525, attached to the second end wall, i.e. in the vicinity of the aperture 505 of the individual antenna.

This second main wall 525 is also flat and parallel (concentric in this case) to the second main wall 520 from which it extends. Due to the third main wall, the distance d which determines the operating wavelength λ of the antenna according to the formula λ/4=d is now in effect doubled, since the distance contained by the individual antenna 500₁-500₄ will be the distance from the second end wall 540 to the first end wall 530 and back.

Another way of expressing this is that the distance which determines the operating wavelength of the antenna now becomes the distance from a point on the second end wall 540 above the third main wall 525 to a point on the first end wall 530, ending in a point on the second end wall 540 below the third main wall 525.

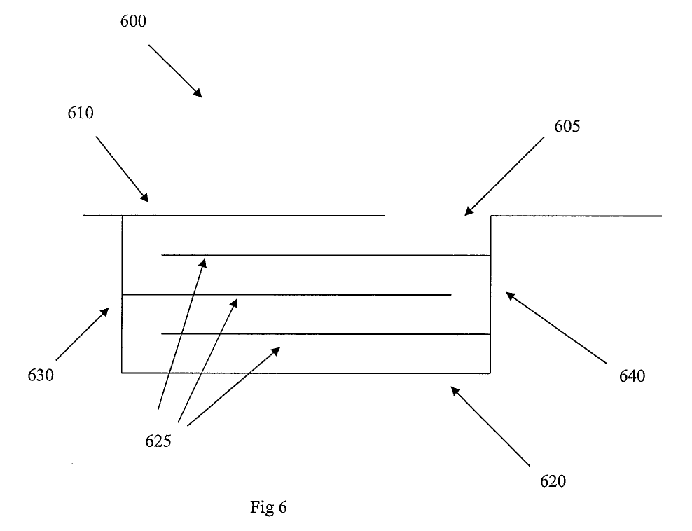

FIG. 6 shows another example of an embodiment 600 using a principle disclosed in FIG. 5: first 610 and second 620 main walls, together with first 630 and second 640 end walls combine to define a cavity together with first and second side walls according to the principles disclosed in connection with FIG. 1b, the cavity having one opening 605.

In order to expand the distance d which determines the operating wavelength λ of the antenna according to the formula λ/4=d, the antenna 600 employs one of the principles disclosed in connection with FIG. 5: the box-like cavity of the antenna 600 comprises a number of intermediate walls 625.

The example in FIG. 6 shows three intermediate walls, but this number can be varied using the principle disclosed: the intermediate walls 625 extend in parallel to the first and second main walls, the intermediate walls being attached alternatingly to the first and second end wall.

Each intermediate wall extends from the side wall to which it is attached towards the other side wall, but has an extension such that the intermediate wall doesn't reach the intermediate wall to which it is not attached. In this way, a labyrinth, in other words a meandering path is created inside the cavity of the antenna 600. The distance d of the formula λ/4=d is thus increased, and will be the total length of the meander path.

1-7. (canceled)

8. An antenna, comprising:
a plurality of walls in an electrically conducting material, said plurality of walls comprising:
a first and a second main wall with respective lengths of extension;
a first end wall; and,
a first and a second side wall;
wherein said walls are arranged so that the first and second main walls extend parallel to each other and are joined by the first end wall, with the side walls also joining the first and second main walls so that a structure containing a cavity with only one opening is formed, said opening comprising a rectangular aperture which can be brought to radiate by a feed connection, and wherein the first and second main walls are curved, said parallel feature making them concentric, thus creating a cylindrically curved box-cavity, said aperture being the only opening in the box, the aperture being oriented in the circumferential direction of said cylinder.

9. The antenna of claim 8, further comprising a second end wall which extends from the second main wall towards the first main wall, wherein the length of extension of the first main wall is such that the second end wall and the first main wall do not meet.

10. The antenna of claim 9, wherein the cavity of the antenna comprises at least one intermediate wall extending in parallel to the first and second main walls, said intermediate wall forming a meandering path inside the cavity of the antenna.

11. The antenna of claim 8, wherein at least part of the cavity of the antenna is filled by a dielectric material other than air.

12. The antenna of claim 8, further comprising:
at least one diode arranged between the first main wall and the second end wall; and,
a DC-layer arranged inside the cavity defined by the walls, said DC-layer being used to create a bias voltage for the diode.

13. The antenna of claim 8, wherein the length of extension of the second main wall is n*λ/4, where λ is the desired operating wavelength of the antenna and n is a positive integer.

14. The antenna of claim 8, wherein electrically conducting material surrounding the aperture is covered by radar absorbing material.
